(19) United States
(12) Patent Application Publication
(10) Pub. No.: US 2005/0038670 A1
(43) Pub. Date: Feb. 17, 2005

(54) Automated method and system for collecting and displaying patient health and financial information from multiple databases

(75) Inventors: Preet Mohan Singh Takkar, Tustin, CA (US); Robert Stephen Mathuny, Corona del Mar, CA (US); Timothy Joe Olsen, Huntington Beach, CA (US)

Correspondence Address: MCDERMOTT WILL & EMERY LLP, 18191 VON KARMAN AVE., IRVINE, CA, 92612-7107, US

(73) Assignee: Dental Technology, Inc.

(21) Appl. No.: 10/636,641

(22) Filed: Aug. 8, 2003

(51) Int. Cl. G06F 17/60

(52) U.S. Cl. 705/2; 705/3; 705/35

(57) ABSTRACT

An automated method for displaying patient health and financial information, together with any patient financial management action items, by collecting information from at least two databases including a first database which includes patient health information comprising patient ID information and healthcare data and a second database which includes patient financial information comprising patient ID information and billing and accounting data. The method includes accessing, in response to a single input of a patient ID information, all patient information from at least the first database and the second database, determining whether there exists patient financial management action items based on predefined business rules and all collected patient health and financial information, displaying all patient health and financial information in a first window of a display, and displaying the patient financial management action items in a second window overlaid onto the first window displaying all patient information, wherein the second window only pops up if there exists an action item.

### BACKGROUND OF THE INVENTION

1. Field of the Invention

The present invention relates generally to a method of automatically collecting and displaying patient health and financial information from a database, and, more particularly, to an automated method of collecting and displaying patient health and financial information from multiple databases and determining and displaying, if necessary, patient financial management action items based on the collected patient information and predefined business rules.

2. Description of the Related Art

Healthcare service is by nature information intensive field, and medical and dental informatics are some of the fastest growing areas of the healthcare industry. Healthcare information systems have been in existence for many years and hundreds of systems and applications are currently available to healthcare service providers. However, most existing healthcare information systems focus on patient record keeping and management. Those systems that do go beyond mere record keeping are mainly geared toward managing diagnostic information and determining tasks related to patient healthcare such as the automated patient diagnostic alert systems. There are no automated systems that specifically focus on management of patient financial information and tasks related to management of patient financial information.

It can be seen, then, there is a need in the art for an automated system and method for displaying patient financial management information as well as determining and displaying patient financial management action items based on patient information data.

Another problem of existing healthcare information systems is that they are “closed” proprietary systems, such as the MUMPS and QSI based systems, that do not talk to each other. Even within a particular system, the applications and databases tend to be isolated, fractured, and generally are not integrated with each other. For example, the applications and databases for patient healthcare information tend to be separate from those for billing, accounting, insurance information. Such separation of information in the existing systems is artificial and inefficient because healthcare operations in reality are not separated along the artificial boundaries. In fact, it is often the case that a healthcare provider needs information from various sources in order to make appropriate healthcare and business decisions. For example, healthcare treatment options available to a patient may depend on the patient's insurance coverage as well as the patient health information.

In the existing systems, different types of information residing in multiple, disparate databases and applications are accessed separately and then consolidated manually by human operators. Consequently, enforcing business rules of a healthcare operation must also be done manually by the operators. Such manual approach is time consuming, and can lead to errors and inconsistency, especially in a busy, complex healthcare operation. The result often is patient financial management that is error-prone, incomplete, inconsistent, inefficient, and delayed. The patient financials are often handled or resolved last, making effective healthcare practice management difficult. Ultimately, inefficiencies in practice management result in adversely affecting the quality of patient care.

Thus, it can be seen that there is a need for an automated system and method to: collect, consolidate, and display all patient health and financial information from multiple databases; and determine and display patient financial action items based on predefined business rules.

### SUMMARY OF THE INVENTION

The present invention addresses the above needs by providing an automated method and system for collecting all patient health and financial information from multiple databases, displaying the information consolidated in one display, determining patient financial action items based on predefined business rules, and, if necessary, displaying the patient financial action items in a pop-up window display.

The multiple databases containing patient health and financial information are accessed in response to an input of patient ID information. All patient health and financial information are collected from the databases and consolidated into a window of a display. Thus, all patient health and financial information are searched and collected by entering only one single input of patient ID information. No other input is necessary. Furthermore, one single input of patient ID information results in display of all patient health and financial information consolidated in a single window of a display.

In addition, patient financial action items are determined from predefined business rules and collected patient information. The patient financial action items, if any, are then displayed in a popup window of the display overlaid onto the window displaying all patient information.

The present invention can be made to accommodate various standards of medical and dental informatics, including the HL7, X12, ACR/NEMA, and ISO TC251, as well as any specific technologies or systems such as MUMPS, QSI, SQL, and relational database systems.

According to one aspect of the invention, the present invention is an automated method for displaying patient health and financial information, together with any patient financial management action items, by collecting information from at least two databases including a first database which includes patient health information comprising patient ID information and healthcare data and a second database which includes patient financial information comprising patient ID information and billing and accounting data. The method including accessing, in response to an input of a patient ID information, all patient information from at least the first database and the second database, determining whether there exists patient financial management action items based on predefined business rules and all collected patient health and financial information, displaying all patient health and financial information in a first window of a display, and displaying the patient financial management action items in a second window overlaid onto the first window displaying all patient information, wherein the second window only pops up if there exists an action item.

The present invention can also be implemented as a networked system or application over various computer network connections. In particular, the present invention can be an Internet based system and application that accesses multiple databases and collects patient information over the Internet. As an Internet application, the user interface can be Web-based, where the patient ID information is entered on a Web application, the collection of patient information is conducted via the World Wide Web protocol, and the display of information utilizes the Web-based display technologies.

According to another aspect of the invention, the present invention is an automated system for collecting and displaying patient health and financial information from multiple databases, and determining and displaying patient financial management action items based on the patient information and business rules, including a computer, and one or more storage devices which includes a patient health information database comprising patient ID information and healthcare data, a patient financial information database comprising patient ID information and billing and accounting data, wherein the patient health information database, patient financial information database, and business rules database and additional data sources are accessible to the computer, wherein the computer processes inputs from an operator such that, in response to an input of a patient ID information, the computer 1) accesses all patient information from the patient health information database and the patient financial information database, 2) accesses the business rules from the business rules database, 3) determines patient financial management action items from the business rules and all patient information, 4) displays all patient information in a first window of a display, and 5) displays the patient financial management action items in a second window overlaid onto the first window displaying all patient information, wherein the second window is displayed only if an action item exists.

According to another aspect of the invention, the present invention is computer-executable process steps for displaying patient health and financial information, together with any patient financial management action items, by collecting information from at least two databases including a first database which includes patient health information comprising patient ID information and healthcare data and a second database which includes patient financial information comprising patient ID information and billing and accounting data, wherein the process steps are stored on a computer-readable medium, the steps including a step for accessing, in response to an input of a patient ID information, all patient information from at least the first database and the second database, a step for determining whether there exists patient financial management action items based on predefined business rules and all collected patient health and financial information, a step for displaying all patient health and financial information in a first window of a display, and a step for displaying the patient financial management action items in a second window overlaid onto the first window displaying all patient information, wherein the second window only pops up if there exists an action item.

In the following description of the preferred embodiment, the reference is made to the accompanying drawings that form a part thereof, and in which is shown by way of illustration a specific embodiment in which the invention may be practiced. It is to be understood that other embodiments may be utilized and changes may be made without departing from the scope of the present invention.

### BRIEF DESCRIPTION OF THE DRAWINGS

Referring now to the drawings in which like reference numbers represent corresponding parts throughout:

FIG. 1 illustrates an outward view of a hardware environment embodying the present invention;

FIG. 2 illustrates an internal systems view of a computing environment embodying the present invention;

FIG. 3 illustrates a flowchart in accordance with the present invention;

FIG. 4 illustrates an example of displaying patient financial information in a first window of a display;

FIG. 5 shows an example of displaying patient financial management action items in a popup window of a display;

FIG. 6 illustrates an example of setting up a new financial arrangement;

FIG. 7 illustrates an example of setting up a healthcare service provided credit financial arrangement;

FIG. 8 illustrates an example of setting up a promissory note financial arrangement;

FIG. 9 illustrates an example of setting up an open case;

FIG. 10 illustrates an example of additional command line functions;

FIG. 11 illustrates an example of Amount Due function to display a breakout of the amount that a patient owes;

FIG. 12 illustrates an example of Balance function to display the breakout of the entire family balance by each dependent on that account;

FIG. 13 illustrates an example of Comments function to display comments entered for the selected patient as it relates to the financial arrangements; and

FIG. 14 illustrates an example of Dispute function to set up and track any amounts disputed by a patient.

### DETAILED DESCRIPTION OF THE INVENTION

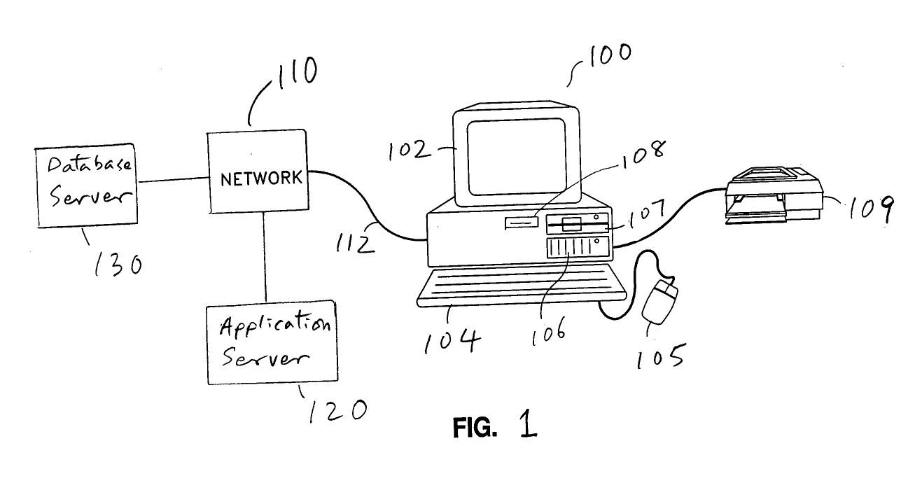

FIG. 1 illustrates an outward view of a hardware environment embodying the present invention. As shown in FIG. 1, the hardware environment can include computer 100, display monitor 102, keyboard 104, mouse 105, fixed disk drive 106, removable disk drive 107, tape drive 108, hardcopy output device 109, computer network 110, computer network connection 112, application server 120, and database server 130.

Computer 100 can be a desktop PC, a laptop, a workstation, a server, a midrange computer, or a mainframe without departing from the scope of the present invention. Display monitor 102 displays the graphics, images, and texts that comprise the user interface for the application of the present invention as well as the operating system programs necessary to operate the computer. An operator of computer 100 uses keyboard 104 to enter commands and data, including the patient ID information, to operate and control the computer operating system programs as well as the application programs. The operator uses mouse 105 to select and manipulate graphics and text objects displayed on display monitor 102 as part of the interaction with and control of computer 100 and applications running on the computer. Mouse 105 can be any type of pointing device, including a joystick, a trackball, or a touch-pad without departing from the scope of the present invention.

The patient information databases can be stored locally on fixed disk drive 106 or can be accessed over network 110 from database server 130 without departing from the scope of the present invention. Moreover, database server 130 can comprise multiple database servers without departing from the scope of the present invention. Fixed disk drive 106 can comprise a number of physical drive units without departing from the scope of the present invention. Fixed disk drive 106 can also be a disk drive farm or a disk array that can be physically located in a separate computing unit without departing from the scope of the present invention.

The patient information management application of the present invention can run locally on computer 100 or can be accessed remotely from application server 120 over network 110 and network connection 112 without departing from the scope of the present invention. Network connection 112 can be a modem connection, a LAN connection including the Ethernet, and a broadband WAN connection including DSL, Cable, T1, T3, Fiber Optics, and Satellite connection without departing from the scope of the present invention. Network 110 can be a LAN network, a corporate WAN network, or the Internet without departing from the scope of the present invention.

Removable disk drive 107 is a removable storage device that can be used to off-load data from computer 100 or upload data onto computer 100. Without departing from the scope of the present invention, removable disk drive 107 can be a floppy disk drive, an Iomega Zip drive, a CD-ROM drive, a CD-Recordable drive (CD-R), a CD-Rewritable drive (CD-RW), a DVD-ROM drive, or any one of the various recordable or rewritable DVD drives such as the DVD-R, DVD-RW, DVD-RAM, DVD+R, or DVD+RW. Operating system programs, applications, and various data files are stored on disks. The files can be stored on fixed disk drive 106 or on a removable media for removable disk drive 107 without departing from the scope of the present invention.

Tape drive 108 is a tape storage device that can be used to off-load data from computer 100 or upload data onto computer 100. Tape drive 108 can be QIC, 4 mm DAT, or 8 mm DLT tape drive without departing from the scope of the present invention.

Hardcopy output device 109 provides an output function for the operating system programs and applications including the patient information management application. Hardcopy output device 109 can be a printer or any output device that produces tangible output objects, including patient information and action item reports, without departing from the scope of the present invention.

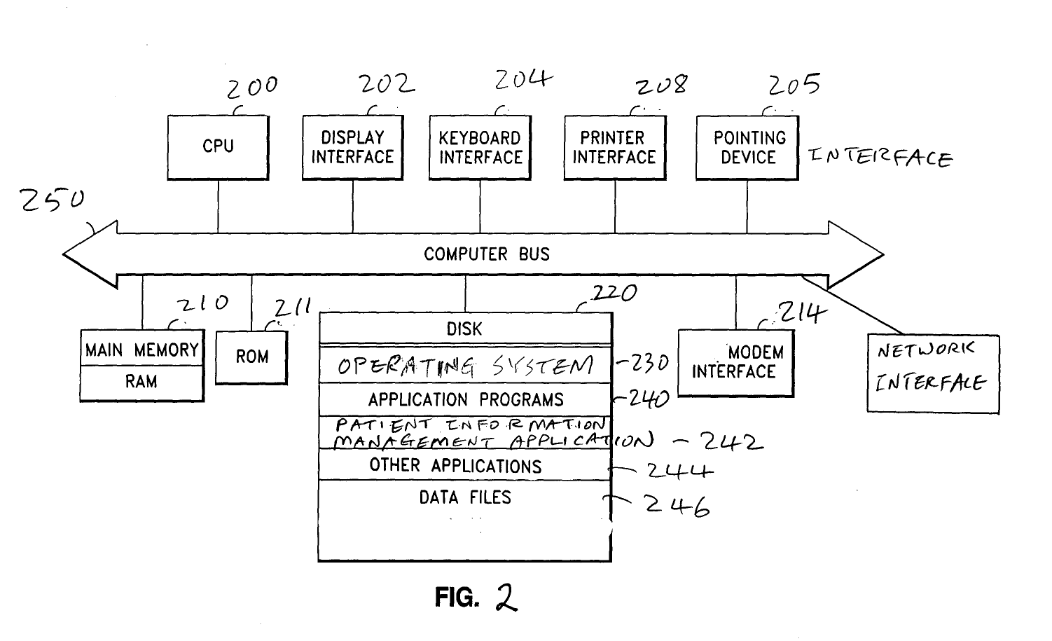

FIG. 2 illustrates an internal systems view of a computing environment embodying the present invention. As shown in FIG. 2, the computing environment can include: CPU 200 where the computer instructions that comprise an operating system or an application, including a virtual reality application, are processed; display interface 202 which provides communication interface and processing functions for rendering graphics, images, and texts on display monitor 102; keyboard interface 204 which provides a communication interface to keyboard 104; pointing device interface 205 which provides a communication interface to mouse 105 or an equivalent pointing device; printer interface 208 which provides a communication interface to hardcopy output device 108; RAM 210 where computer instructions and data can be stored in a volatile memory device for processing by CPU 200; ROM 211 where low-level systems code or data are stored in a non-volatile memory device; disk 220 which can comprise fixed disk drive 106 and removable disk drive 107, where the files that comprise operating system 230, application programs 240 (including patient information management application 242 and other applications 244) and data files 246 are stored; modem interface 214 which provides a communication interface to computer network 116 over a modem connection; and computer network interface 216 which provides a communication interface to computer network 116 over a computer network connection. The constituent devices and CPU 200 communicate with each other over computer bus 250.

CPU 200 can be any of the high-performance CPUs, including an Intel CPU, a PowerPC CPU, a MIPS RISC CPU, a SPARC CPU, a Alpha CPU or a proprietary CPU for a mainframe, without departing from the scope of the present invention. CPU 200 in computer 100 can comprise more than one processing units, including a multiple CPU configuration found in high-performance workstations and server, or a multiple scalable processing units found in mainframes.

Operating system 230 can be: Windows NT/2000/XP Workstation; Windows NT/2000/XP Server; a variety of Unix-flavor operating systems, including AIX for IBM workstations and servers, SunOS for Sun workstations and servers, Linux for Intel CPU-based workstations and servers, HP-UX for HP workstations and servers, mix for SGI workstations and servers, VAX/VMS for DEC computers, OpenVMS for Alpha-based computers, Mac OS X for PowerPC based workstations and servers; or a proprietary operating system for mainframe computers.

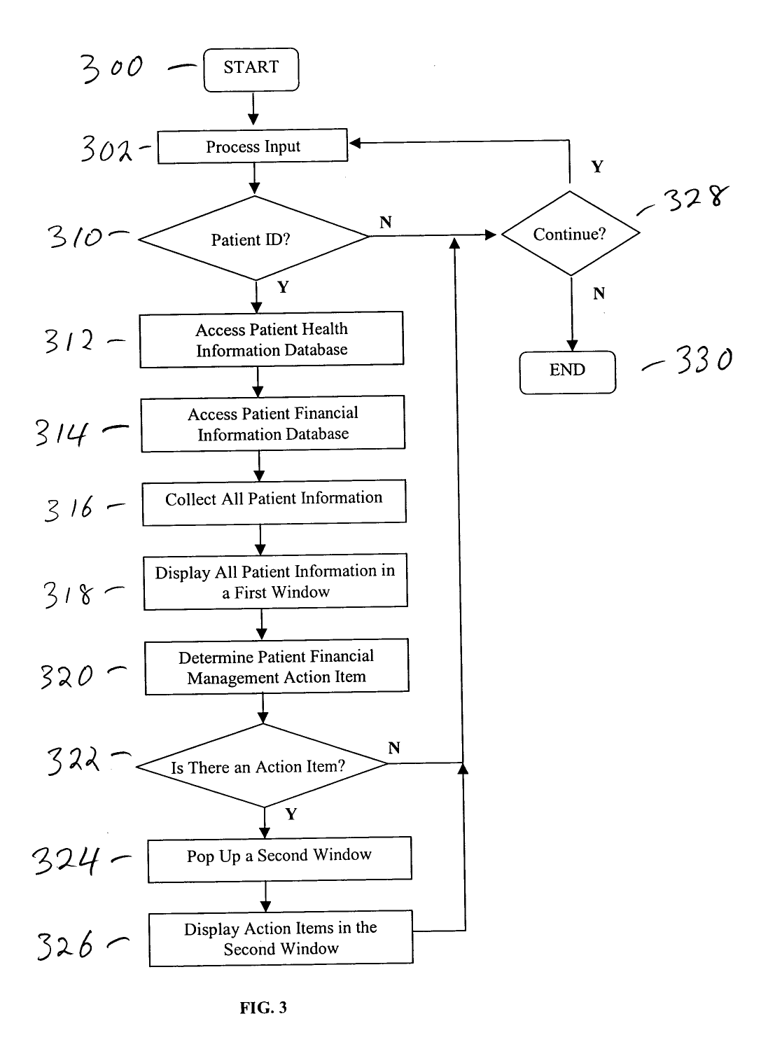

FIG. 3 illustrates a flowchart in accordance with the present invention.

Upon starting (Step 300), the system processes inputs (Step 302) from an operator. If the input is patient ID information (Step 310), patient health information database is accessed (Step 312) along with the patient financial information database (Step 314). Patient ID information can be a social security number or an identification number assigned by the healthcare service provider. From the patient health and financial information databases and other data sources, all patient information is collected (Step 316). Only one single input of patient ID information is needed to launch the search and access of multiple data sources in order to collect all patient information. No other input is necessary. The collected all patient information then is consolidated and displayed in a first window of display 102 (Step 318). Upon input of a patient ID, it is also determined whether any patient financial action item exists for the patient account based on the collected patient information and predefined business rules (Step 320). The business rules can be implemented as a database and/or programming code within the application of the present invention without departing from the scope of the present invention. If one or more of action items exist (Step 322), then a second window pops up on display 102 (Step 324), and the patient financial management action items are displayed in the popup window overlaid on the first window (Step 326). Depending on the operators choice to continue (Step 328), the system can process further inputs (Step 300) or terminate (Step 330).

The accessed and searched databases and data sources can be located on fixed disk drive 106, removable disk drive 107, tape drive 109, application server 120, or database server 130 without departing from the scope of the present invention. The present invention can also be a networked system or application running over computer network 110 without departing from the scope of the present invention. In particular, the present invention can be a client-server system operating over computer network 110, where multiple client systems connect to a central server. The client systems can also be located at multiple field or branch offices and connect remotely to the server system. Furthermore, the present invention can be an Internet based system and application that accesses multiple data sources and collects patient information over the Internet. As an Internet application, the user interface can be Web-based, where the patient ID information is entered on a Web application, the collection of patient information is conducted via the World Wide Web protocol, and the display of information utilizes the Web-based display technologies.

The windowing system of the present invention can be character-based windows, Microsoft Windows, X-Window systems such as X/Motif and X/OpenLook, and Quartz and Aqua for Mac OS, without departing from the scope of the present invention.

The present invention can be made to accommodate various standards of medical and dental informatics, including the HL7 for healthcare records, X12 for insurance information, ACR/NEMA for images, and ISO TC251 for health information fields, without departing from the scope of the present invention.

The present invention can be implemented employing any specific technologies or systems including MUMPS, QSI, SQL, and relational database systems such as Oracle, Sybase, Informix, and Microsoft SQL Server, as well as other database systems such as Microsoft Access, FoxPro, and dBase, without departing from the scope of the present invention.

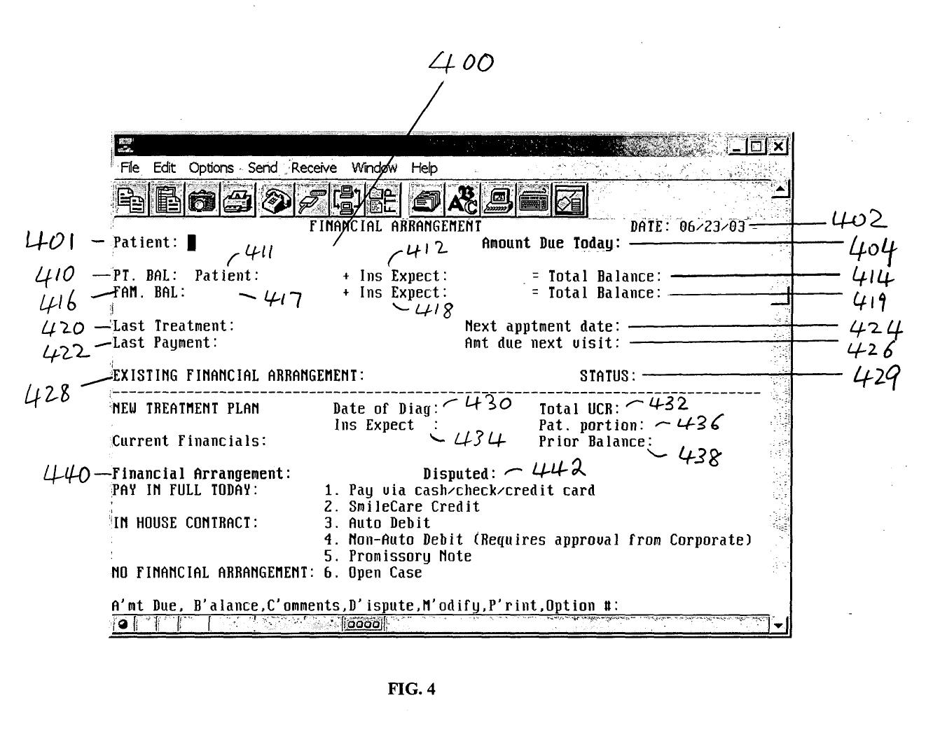

FIG. 4 illustrates an example of displaying patient financial information in a single window of a display triggered by only one single input of patient ID information. As shown in FIG. 4, patient financial information are displayed in window 400. Although FIG. 4 depicts displaying a certain set of patient information, it is to be understood that more or less information can be provided in window 400 without departing from the scope of the present invention. Window 400 can also be scrolled up and down to provide more information than can be fit into the physical size or screen real estate of display 102 and window 400. Information fields in window 400 can also be displayed in a recursive, expandable and collapsible outline form such that the operator can select and control the level, scope, and granularity of the information displayed. Furthermore, it is also to be understood that, although window 400 and windows described hereinafter are in character-based window form, the windows of the present invention can be any graphical and character-based windows, including Microsoft Windows, X-Window systems such as X/Motif and X/OpenLook, and Quartz and Aqua for Mac OS, without departing from the scope of the present invention.

As shown in FIG. 4, patient ID information is entered on Patient input and display field 401. Patient ID information can be a social security number or an identification number assigned by the healthcare service provider. The entered patient ID remains in display on Patient input and display field 401 until the operator enters a new patient ID information. All patient health and financial information are searched and collected when only one single input of patient ID information is entered in Patient input and display field 401. No other input is necessary.

Also shown in FIG. 4 are: Date field 402 which shows the current date; Amount Due Today field 404 which shows any amount that a patient owes on the current day which may be any prior balance or any delinquent amount of an existing financial arrangement or contract; Patient Balance field 410 which comprises Patient field 411 for displaying expected patient payment portion, Ins Expect field 412 for displaying expected insurance coverage portion, and Total Balance field 414 for displaying the sum total of the amounts in Patient field 411 and Ins Expect field 412; Family Balance field 416 for a family account which comprises Patient field 417 for displaying expected patient payment portion and Ins Expect field 418 for displaying expected insurance coverage portion, and Total Balance field 419 for displaying the sum total of the amounts in Patient field 417 and Ins Expect field 418; Last Treatment field 420 for displaying the date of last treatment for the patient; Last Payment field 422 for displaying an amount of last payment; Next Appointment Date field 424 for displaying the date of next appointment; Amount Due Next Visit field 426 for displaying total amount due on next visit; Existing Financial Arrangement field 428 for displaying any existing financial arrangement; and Status field 429 for displaying the status of the arrangement such as Current or Delinquent.

Shown further in FIG. 4 are information fields for a new treatment plan, if applicable. Shown in FIG. 4 are: Date of Diag field 430 for displaying the date of diagnosis; Total UCR field 432 for displaying total UCR (Usual and Customary Rate for insurance billing) amount for the last diagnosis performed on the patient; Ins Expect field 434 for displaying expected insurance coverage; Patient Portion field 436 for displaying expected patient payment portion; and Prior Balance field 438 for displaying any prior patient balance. The amount displayed in Financial Arrangement field 440 is the total amount for which a financial arrangement must be setup with the patient. This amount includes any new treatment and any prior delinquent amount. The amount displayed in Disputed field 442 is the total amount that the patient has disputed for payment. This amount is not included in the total amount for which a financial arrangement must be set. A report of all disputed amounts can be generated daily, printed out on hardcopy output device 109, and reviewed by the patient collection department.

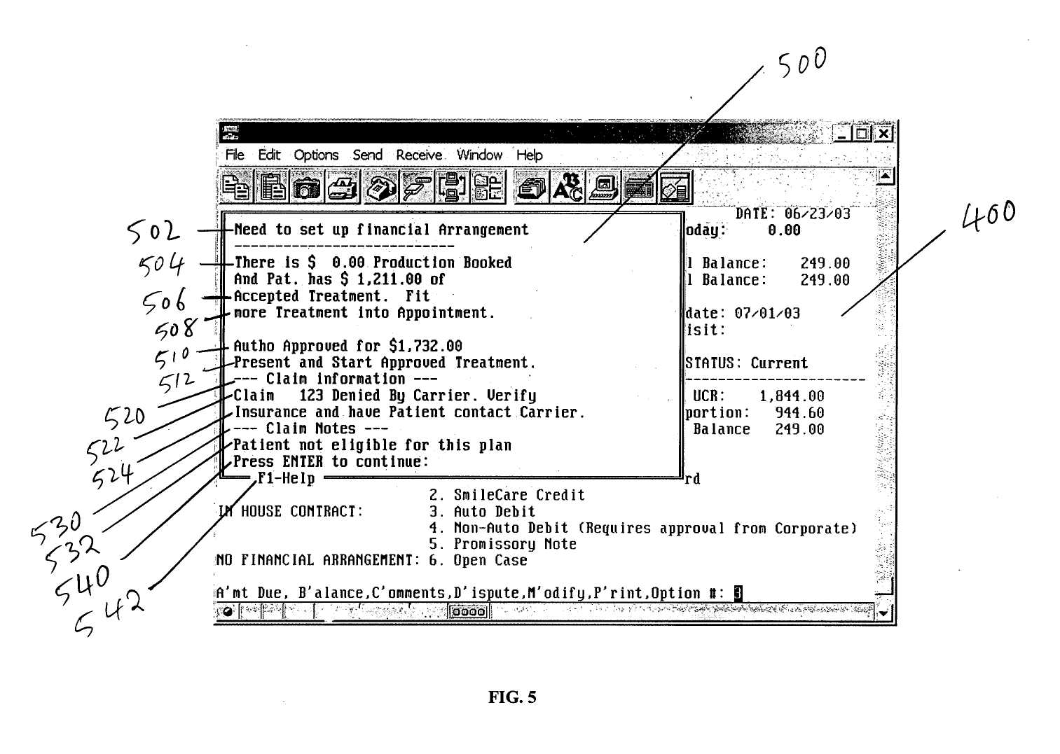

FIG. 5 shows an example of displaying patient financial management action items in a popup window of a display. Shown in FIG. 5 is popup window 500 overlaid on display window 400. Popup window 500 is displayed when it is determined that one or more patient financial action item exist for the patient account based on collected patient information and predefined business rules. Without departing from the scope of the present invention, an example of the business rules is given as follows:

1) Program determines the current patient and family balance for that account.

2) Program determines the existing financial arrangement for that patient.

3) Program determines whether the patient is current or delinquent on the existing financial arrangement. If the patient is delinquent, program will determine the delinquent amount. If the patient is delinquent, a popup window is displayed with an appropriate message indicating that the patient is delinquent and that the delinquent amount is to be collected.

4) Program determines if the patient has any future accepted treatment. If the patient has any future treatment, program searches database to see if any financial arrangement exists for the future accepted treatment. If no arrangement exists, a popup window is displayed with an appropriate message indicating that a financial arrangement needs to be setup for the future accepted treatment.

5) Program determines if the existing financial arrangement is for the correct amount or not. For example, a patient could have an arrangement setup for a certain amount to be paid in subsequent visits, and the patient could have been diagnosed with additional work. The financial arrangement will need to be modified accordingly to reflect the new and correct patient portion. If a correct financial arrangement does not exist, a popup window is displayed asking the operator to modify the existing arrangement to reflect the correct amount.

6) Program determines the total amount of treatment booked for the next appointment and compares it to the total treatment the patient has accepted. If possible, the operator is directed to review the services to be performed during the next appointment to determine if additional services can be provided based on the accepted treatment.

7) Program determines if patient had some services that need to be pre-authorized by the insurance company. If so, and if the services have been pre-authorized, the operator is directed to consult with the patient and schedule appointments for those services.

8) Program determines if the patient had any insurance claims that are unpaid or were denied by the insurance company. If so, the operator is directed to inform the patient of the denied claim and discuss appropriate follow-up action.

The business rules can be implemented as a database and/or programming code within the application of the present invention without departing from the scope of the present invention. The patient financial management action items in popup window 500 can include one or more of the following items: information that a financial arrangement with the patient is less than any prior balance plus a cost for new treatment, and an instruction to modify the financial arrangement accordingly; an instruction that it is necessary to setup a financial arrangement with the patient; an instruction to collect promissory note due for an indicated amount; an instruction to collect unpaid balance or setup a new financial arrangement; an instruction to charge out unpaid balance to a service provider credit account; an instruction to collect on an auto debit contract for an indicated amount; an instruction to see comments for the patient; information that the patient has a remaining amount in a contract and an instruction to arrange additional treatment and make appointment; information that a claim was denied by an insurance carrier and an instruction to verify insurance coverage and have the patient contact the insurance carrier.

Shown in FIG. 5 are: “Need to set up financial Arrangement” action item (502) that instructs the operator that it is necessary to setup a financial arrangement with the patient; information that the patient has $0.00 “Production Booked” (504) and has “Accepted Treatment” (506) for the amount of $1,211.00; “Fit more Treatment into Appointment” action item (508) to instruct the operator to arrange additional treatment and make appointment; information that the patient has been “Authorized or Approved” (510) for the amount of $1,732; and “Present and Start Approved Treatment” action item (512) to instruct the operator to proceed with arranging the approved treatment. Also shown in FIG. 5, as displayed in popup window 500, are: “Claim Information” heading (520) for insurance claim information; information “Claim Denied by Carrier” (522); and “Verify Insurance and have Patient contact Carrier” action item (524). Finally, FIG. 5 shows, as displayed in popup window 500, “Claim Notes” heading (530) for additional notes or comments on the claim, and information “Patient not eligible for this plan” (532).

The information and action items in popup window 500 assist the operator in determining what appropriate steps to take regarding the financial arrangement for that patient based on predefined business rules and collected patient information. Automated display of patient financial information and action items in popup window 500 eliminates the need for the time-consuming, cumbersome, and error-prone process of ascertaining and enforcing business rules manually. By ensuring that all necessary appropriate financial management actions are taken without delay, the display of information and action items in popup window 500 facilitates patient financial management that is error-free, complete, efficient, and timely. Efficient management of financials in a healthcare service operation would ultimately contribute to ensuring and maintaining quality patient care.

As shown in FIG. 5, when the operator is finished with popup window 500, the operator can press ENTER to continue (540), whereupon popup window 500 disappears and the operator can continue to interact with display window 400. Pressing F1 (542) will bring up a window with appropriate on-line help documentation.

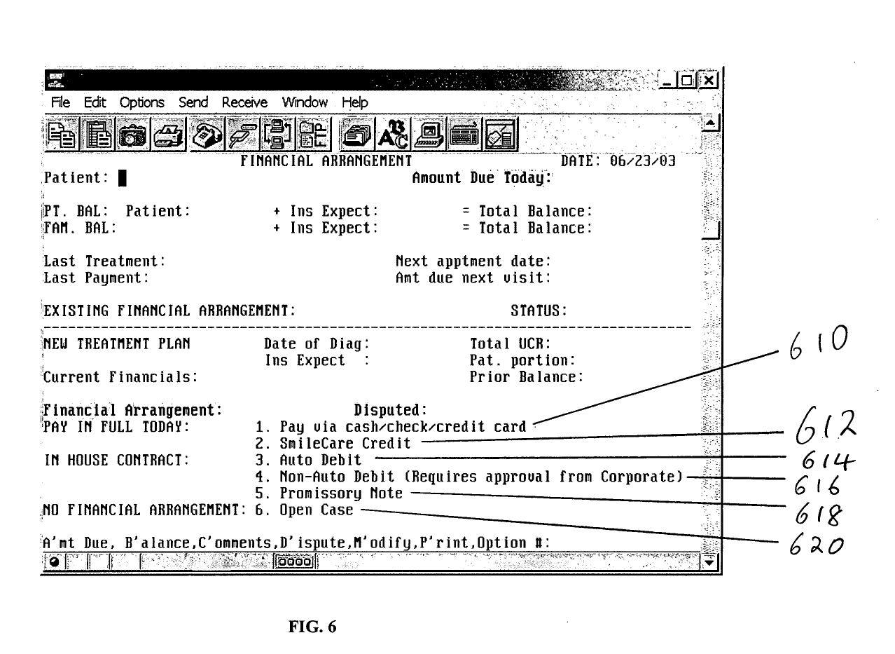

FIG. 6 illustrates an example of setting up a new financial arrangement. In particular, FIG. 6 illustrates displaying new financial arrangement choices in the same window as the patient information, i.e., window 400 shown in FIG. 4, and hence providing all patient information functions in a single window. As shown in FIG. 6, new financial arrangement choices can include: option “1. Pay via cash/check/credit card” (610) to pay in full by cash, check, credit card; option “2. SmileCare Credit” (612) to set up healthcare service provided credit; option “3. Auto Debit” (614) to setup auto debit in-house contract; option “4. Non-Auto Debit” (616) to setup non-auto debit in-house contract; option “5. Promissory Note” (618) to setup a promissory note financial arrangement; and option “6. Open Case” (620) to set up for patients who have been diagnosed but have not accepted treatment yet. When the operator selects one of these options to set up a new financial arrangement, the operator is taken to a new display screen for the selected financial arrangement.

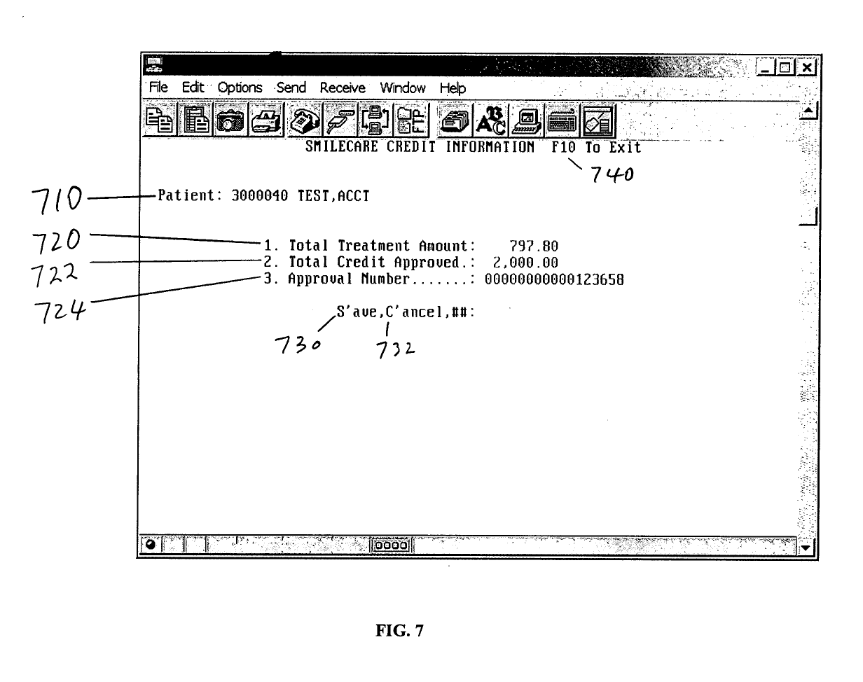

FIG. 7 illustrates an example of setting up a healthcare service provided credit financial arrangement. Patient field 710 displays the patient ID information. Total Treatment Amount field 720 displays the total treatment amount pulled automatically from “Financial Arrangement” field 440 of display window 400. The operator can access Total Treatment Amount field 720 and modify the amount entered in the field. Total Credit Approved field 722 is for entering the total Line of Credit for which the patient has been approved, and Approval Number field 724 is for entering the authorization/approval code received from the Credit Card company. The operator can press “S” (730) to save the information entered on this screen or press “C” (732) to cancel. Pressing “F10” (740) will cause this display screen to exit.

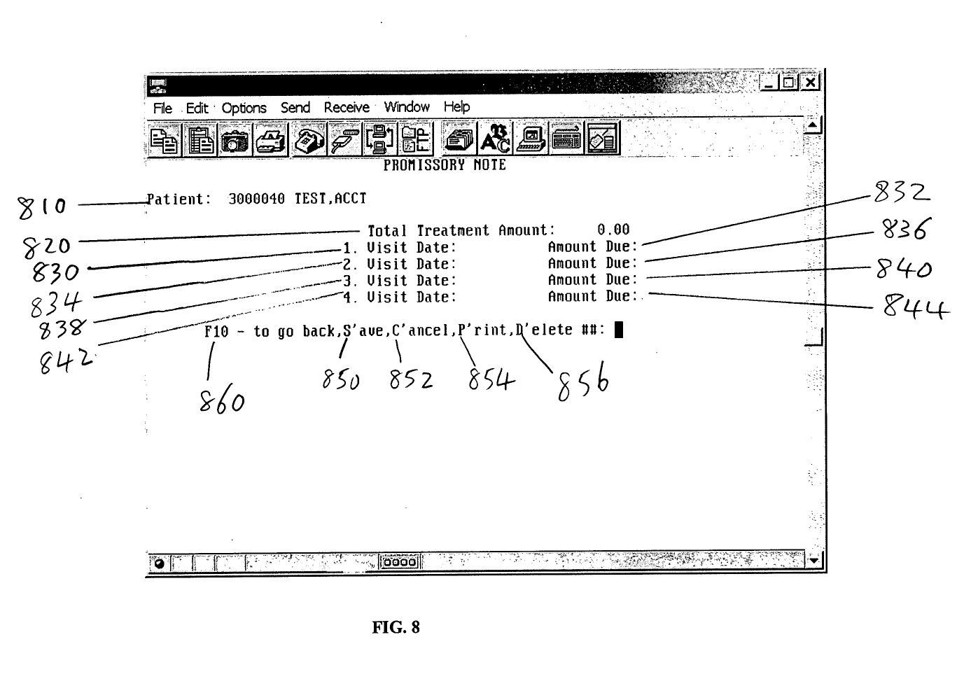

FIG. 8 illustrates an example of setting up a promissory note financial arrangement. A promissory note financial arrangement is to be used for patients who do not want to be setup on an in-house contract (auto debit or non-auto debit), cannot pay in full and do not want to use healthcare provided credit. Patient field 810 displays the patient ID information. Total Treatment Amount field 820 displays the total treatment amount pulled automatically from “Financial Arrangement” field 440 of display window 400. The operator can access Total Treatment Amount field 820 and modify the amount entered in the field. Visit Date field 830 is for entering and displaying the first visit date for the patient, and Amount Due field 832 is for entering and displaying the amount due on the day of first visit. Visit Date field 834 is for entering and displaying the second visit date for the patient, and Amount Due field 836 is for entering and displaying the amount due on the day of second visit. Visit Date field 838 is for entering and displaying the third visit date for the patient, and Amount Due field 840 is for entering and displaying the amount due on the day of third visit. Visit Date field 842 is for entering and displaying the fourth visit date for the patient, and Amount Due field 844 is for entering and displaying the amount due on the day of fourth visit. The visits and payment break-down can be less or more than four without departing from the scope of the present invention. The operator can press “S” (850) to save the information entered on this screen or press “C” (852) to cancel. Pressing “P” (854) will print a patient financial arrangement form and the terms of the promissory note. Pressing “D” (856) will delete the promissory note financial arrangement. Pressing “F10” (860) will cause this display screen to exit.

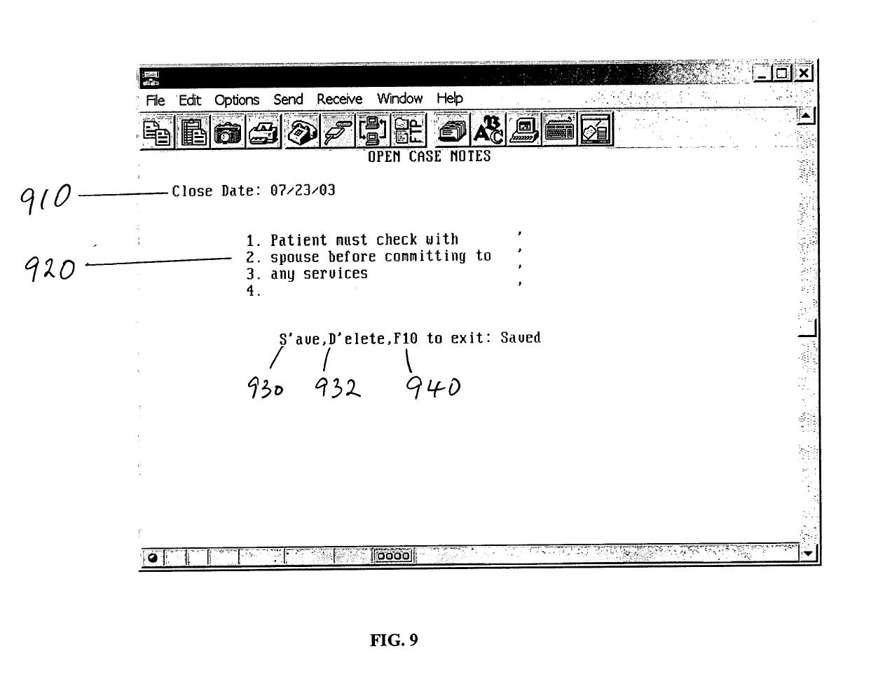

FIG. 9 illustrates an example of setting up an open case. An open case should be setup for patients who have been diagnosed but have not accepted treatment yet. This option allows for follow-up with those patients who are undecided on their treatment. Close Date field 910 is for entering and displaying the due date by which time the case must be closed. Field 920, comprising lines 1 to 4, is for entering and displaying comments related to the case. The operator can press “S” (930) to save the information entered on this screen. Pressing “D” (932) will delete the promissory note financial arrangement. Pressing “F10” (940) will cause this display screen to exit.

The present invention can further provide the following functions without departing from the scope of the present invention: Amount Due function to display a breakout of the amount that a patient owes; Balance function to display the breakout of the entire family balance by each dependent on that account; Comments function to display comments entered for the selected patient as it relates to the financial arrangements; Modify function to modify an existing financial arrangement; Dispute function to set up and track any amounts disputed by a patient; and Print function to print various reports. These functions may be available as Command Line commands without departing from the scope of the present invention.

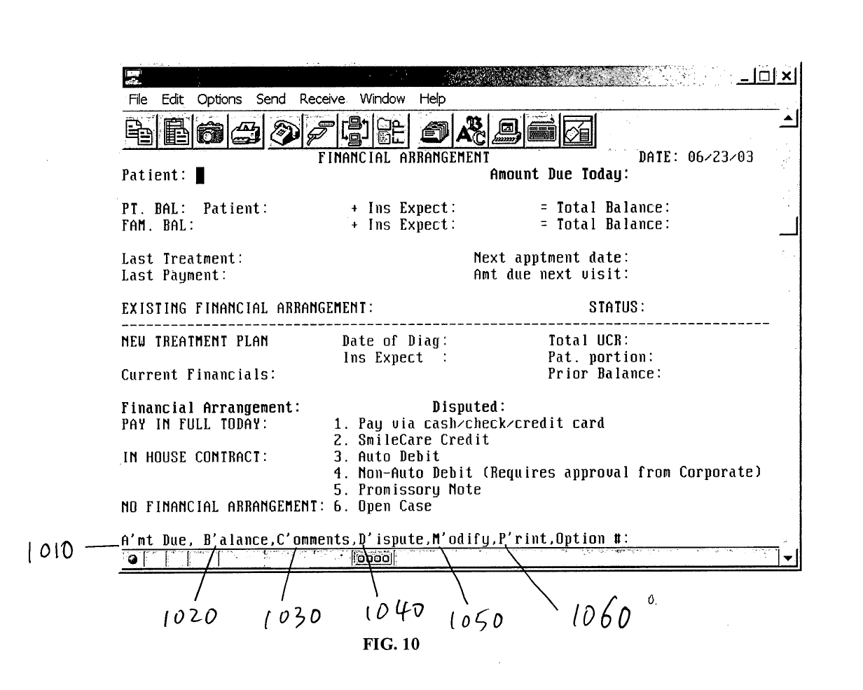

FIG. 10 illustrates an example of additional command line functions. Specifically, FIG. 10 illustrates displaying additional command line functions in the same window as the patient information, i.e., window 400 shown in FIG. 4, and hence providing all patient information functions in a single window. As shown in FIG. 10, A'mt Due command 1010 invokes the Amount Due function when “A” is pressed, B'alance command 1020 the Balance function when “B” is pressed, C'omments command 1030 the Comments function when “C” is pressed, D'ispute command 1040 invokes the Dispute function when “D” is pressed, M'odify command 1050 the Modify function when “M” is pressed, and P'rint command 1060 the Print function when “P” is pressed.

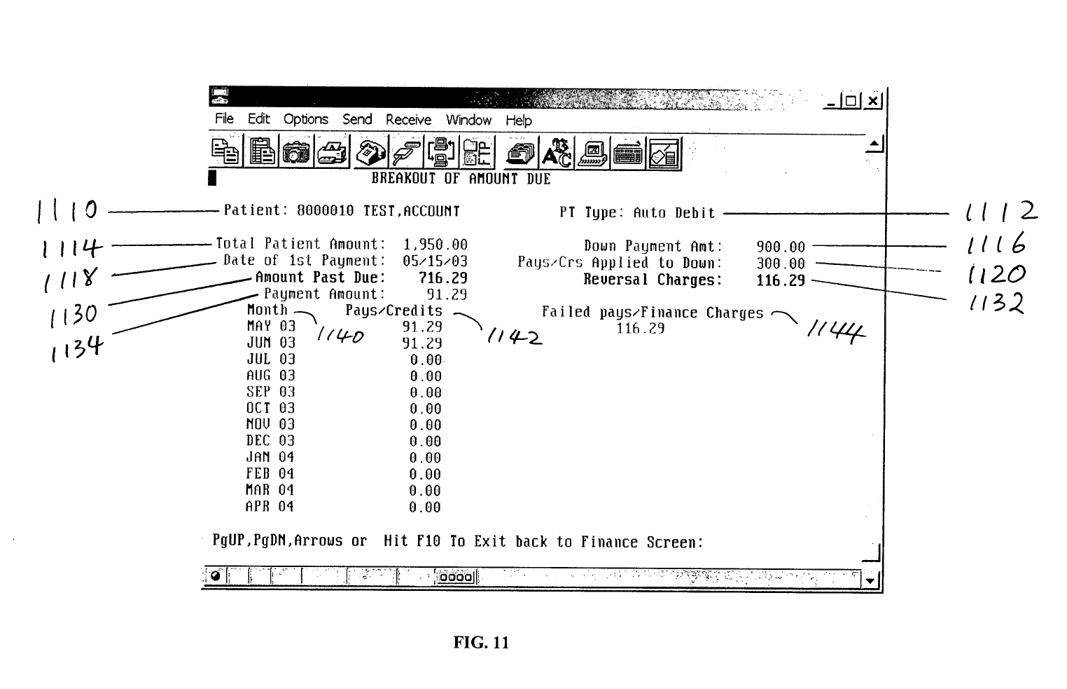

FIG. 11 illustrates an example of Amount Due window to display a breakout of the amount that a patient owes. This window displays the current financial arrangement and a breakout of the payments made and any reversals/finance charges since the contract was setup. As shown in FIG. 11, Patient field 1110 displays the patient ID information, and PT Type field 1112 displays the type of in-house contract the patient is currently on. FIG. 11 illustrates an example where there are two possible types of in-house contracts: Auto Debit (A monthly debit is automatically done from the patients bank account or the credit card provided) or Non-Auto Debit (the patient must mail in a payment for the correct amount each month by an agreed upon date). Also shown in FIG. 11 are: Total Patient Amount field 1114 for displaying the total amount the patient has been contracted for; Down Payment Amt field 1116 for displaying the total down payment amount the patient paid or is to pay; Date of 1st Payment field 1118 for displaying the date the first payment for the contract is due; and Pays/Crs applied to Down field 1120 for displaying the total amount of payments and credits applied towards the down payment (as setup in the contract). FIG. 11 illustrates a situation where the patient was supposed to make a down payment of $900 but only paid $300 down.

Shown further in FIG. 11 are: Amount Past Due field 1130 which displays the total amount the patient is currently past due by; Reversal Charges field 1132 which displays a sum of all reversal charges posted to the account due to various failed payments, NSF's etc.; and Payment Amount field 1134 which displays the total amount of the monthly payment the patient is supposed to make (or amount that will be deducted from patients bank account/credit card if the patient is on auto debit). FIG. 11 further illustrates listing of payments by month in a column format. Under Month header 1140 a month of a year is displayed; under Pays/Credits header 1142 the total payments received and credits applied to the patients account during that month; and under Failed Pays/Finance Charges heading 1144 the amount that was “reversed” due to failed payments, NSF charges etc. and the total finance charges posted due to the failed payments during that month. In the example illustrated in FIG. 11, the patient is past due by $716.29. The amount of $600 was unpaid for down payment; the first payment for the month of May 2003 for the amount of $91.29 did not clear; and a $25 finance charge for failed payment was posted.

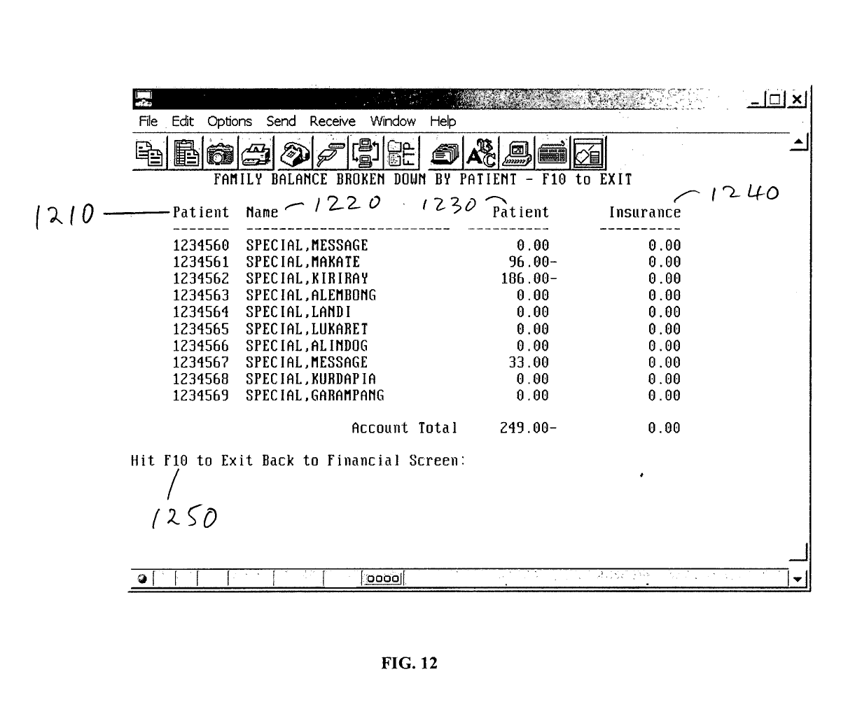

FIG. 12 illustrates an example of Balance window to display the breakout of the entire family balance by each dependent on that account. For each dependent on the account, the window displays the total patient balance and the total insurance balance. As shown in FIG. 12, for each dependent, patient ID is displayed under Patient header 1210, patient name under Name header 1220, total patient balance under Patient header 1230, and total insurance balance for the patient under Insurance header 1240. Pressing “F10” (1250) will cause this display screen to exit.

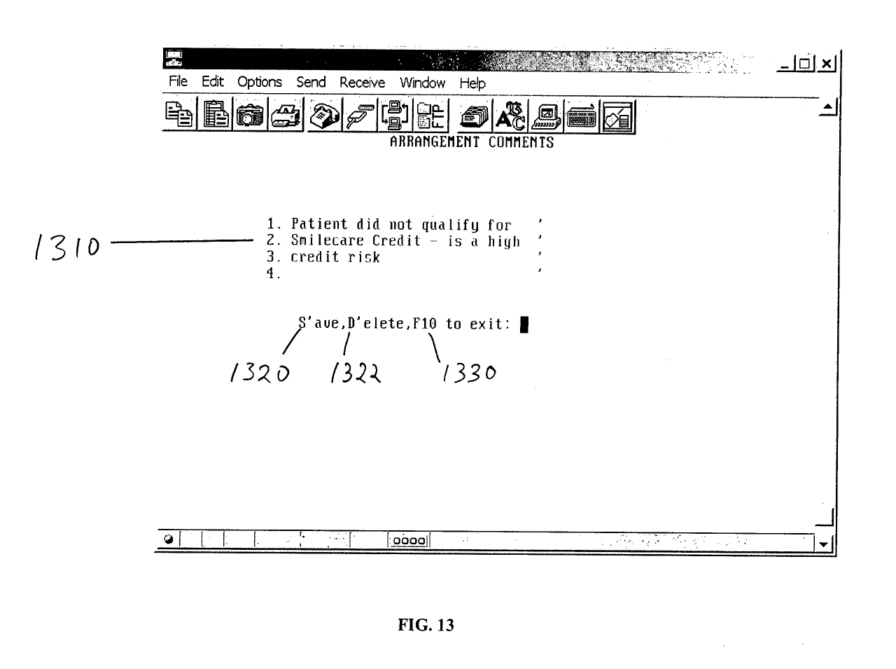

FIG. 13 illustrates an example of Comments function to enter and display comments for the selected patient as it relates to the financial arrangements. As shown in FIG. 13, comments are displayed in field 1310, comprising lines 1 to 4. Although FIG. 13 depicts comments displayed in numbered line form, it is to be understood that comments can be displayed in any text display form without departing from the scope of the present invention. The operator can press “S” (1320) to save the information entered on this screen. Pressing “D” (1322) will delete the comment information. Pressing “F10” (1330) will cause this display screen to exit.

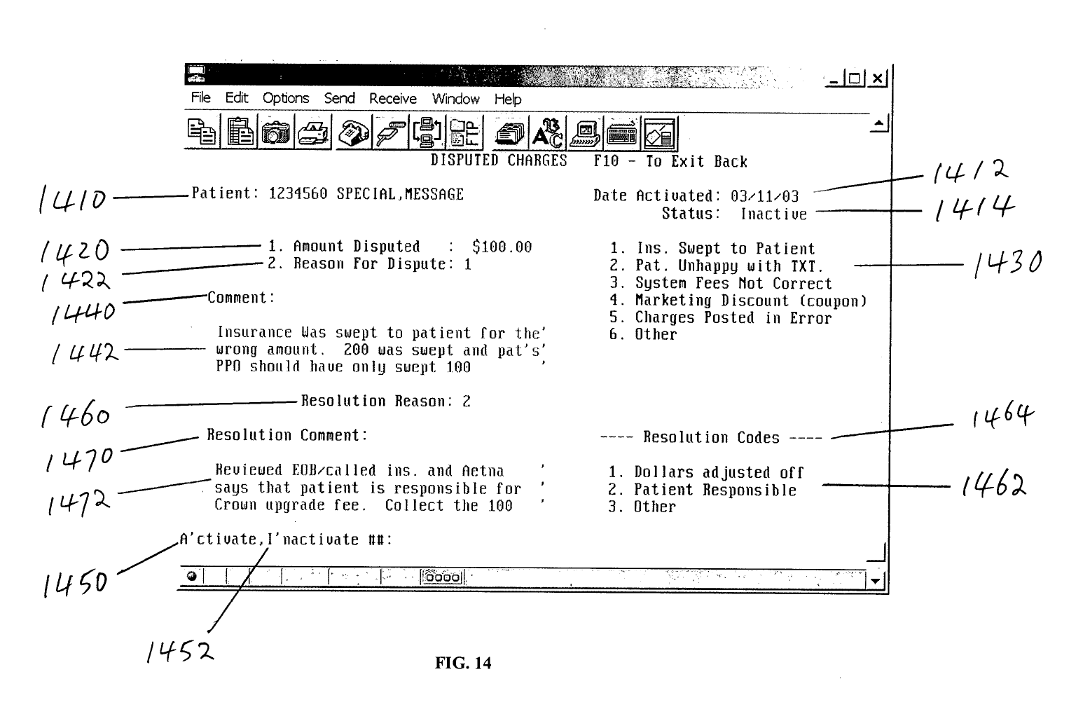

FIG. 14 illustrates an example of Dispute window to set up and track any amounts disputed by a patient. As shown in FIG. 14, patient ID information can be entered and displayed in Patient field 1410. The patient ID number as well as the patient name are displayed. Also shown in FIG. 4 are: Date Activated field 1412 for entering and displaying the date of dispute activation, and Status field 1414 for entering and displaying the status of the dispute. Amount Disputed field 1420 is for entering and displaying the amount of dispute. Reason For Dispute field 1422 is for entering and displaying the reason code, which can be one of the pre-defined reasons 1430. Comments can be entered and displayed under Comment heading 1440 in the comment field 1442.

As further shown in FIG. 14, pressing “A” in the command line invokes Activate command 1450 to activate the dispute setup. Pressing “I” will invoke Inactivate command 1452. Once a patient has disputed an amount, the system will take the disputed amount into consideration for setup of new financial arrangements. The total amount to be setup on a financial arrangement will exclude the total disputed amount. A “dispute amount” report can be run and reviewed each day by the patient collection department. Once a dispute is resolved, either the disputed amount (in it's entirety or a part of) is written off or the patient is still responsible for that amount.

When “I” is pressed to inactivate and close the dispute, the cursor will move to the Resolution Reason field 1460, whereupon the operator can select the appropriate resolution code which can be one of resolution codes 1462 displayed under Resolution Codes header 1464. Comments related to resolution of the dispute can be entered and displayed under Comment heading 1470 in the comment field 1472.

Without departing from the scope of this invention, the following reports can be made available:

1) Pre-Appointment Report: This report provides a summary of the existing financials for a patient with upcoming appointment and indicates what amount is owed by the patient and must be collected at the time of the visit. This report is to be utilized while auditing charts for upcoming appointments.

2) Post-appointment report: This report provides a summary of all financial activity for patients who had an appointment the previous day. The report contains the amount owed by patient prior to the appointment, if the amount owed was collected or not, what financial arrangements were setup, and what new charges were posted or treatment entered for that patient. This report is a good oversight tool to ensure that all policies/procedures for patient financial arrangements are being followed.

3) Disputed Charges report: This report provides a list of all charges disputed by the patient and setup by the offices in the “Dispute Charges” section. This report is to be run daily and reviewed by the patient collection department. All disputes should be resolved either by writing off the amount (part of or full amount) disputed by the patient or by providing a justification why the patient owes the money and attempting to collect from the patient.

4) Open Case report: This report provides a list of patients who have been diagnosed but have not yet accepted treatment and were setup as an “Open Case”. This report should be run on a weekly basis and the patients with open cases should be called back to either have the patient accept treatment (which should be accompanied by scheduling an appointment to have the patient come in to start treatment) or close the case without the services being accepted.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. An automated method for displaying patient health and financial information, together with any patient financial management action items, by collecting information from at least two databases including a first database which includes patient health information comprising patient ID information and healthcare data and a second database which includes patient financial information comprising patient ID information and billing and accounting data, the method comprising the steps of:
accessing, in response to an input of a patient ID information, all patient information from at least the first database and the second database;
determining whether there exists patient financial management action items based on predefined business rules and all collected patient health and financial information;
displaying all patient health and financial information in a first window of a display; and
displaying the patient financial management action items in a second window overlaid onto the first window displaying all patient information, wherein the second window only pops up if there exists an action item.

2. The method of claim 1, wherein the patient health and financial information in the first window includes a current date, any amount that a patient owes on the current day, total balance for a family member dependent to the patient, total family balance for a family account, an amount of payment last received and a date of last treatment, a date of next appointment and total amount due on the date of next appointment, any existing financial arrangement and a status of the arrangement, and, for a new treatment plan, a date of diagnosis, a total Usual and Customary Rate (UCR) amount, expected insurance coverage, expected patient payment amount, and any prior balance; and
wherein the patient financial management action items in the second window include one or more of information that a financial arrangement with the patient is less than any prior balance plus a cost for new treatment, and an instruction to modify the financial arrangement accordingly, an instruction that it is necessary to setup a financial arrangement with the patient, an instruction to collect promissory note due for an indicated amount, an instruction to collect unpaid balance or setup a new financial arrangement, an instruction to charge out unpaid balance to a service provider credit account; an instruction to collect on an auto debit contract for an indicated amount, an instruction to see comments for the patient, information that the patient has a remaining amount in a contract and an instruction to arrange additional treatment and make appointment, information that a claim was denied by an insurance carrier and an instruction to verify insurance coverage and have the patient contact the insurance carrier.

3. The method of claim 1, wherein the input of a patient ID information and accessing all patient information from at least the first database and the second database are conducted over a computer network.

4. The method of claim 3, wherein the input of a patient ID information and accessing all patient information from at least the first database and the second database are conducted remotely over a computer network from multiple branch offices.

5. The method of claim 3, wherein the input of a patient ID information and accessing all patient information from at least the first database and the second database are conducted over Internet.

6. The method of claim 1, wherein all patient information in the first window are displayed in a recursive, expandable and collapsible outline form.

10. An automated system for collecting and displaying patient health and financial information from multiple databases, and determining and displaying patient financial management action items based on the patient information and business rules, comprising:
a computer; and
one or more storage devices which includes a patient health information database comprising patient ID information and healthcare data, a patient financial information database comprising patient ID information and billing and accounting data, wherein the patient health information database, patient financial information database, and business rules database and additional data sources are accessible to the computer,
wherein the computer processes inputs from an operator such that, in response to an input of a patient ID information, the computer 1) accesses all patient information from the patient health information database and the patient financial information database, 2) accesses the business rules from the business rules database, 3) determines patient financial management action items from the business rules and all patient information, 4) displays all patient information in a first window of a display, and 5) displays the patient financial management action items in a second window overlaid onto the first window displaying all patient information, wherein the second window is displayed only if an action item exists.

11. The system of claim 10, wherein the patient information in the first window of a display includes a current date, any amount that a patient owes on the current day, total balance for a family member dependent to the patient, total family balance for a family account, an amount of payment last received and a date of last treatment, a date of next appointment and total amount due on the date of next appointment, any existing financial arrangement and a status of the arrangement, and, for a new treatment plan, a date of diagnosis, expected insurance coverage, expected patient payment amount, and any prior balance and wherein the patient financial management action items in the second window includes one or more of information that a financial arrangement with the patient is less than any prior balance plus a cost for new treatment, and an instruction to modify the financial arrangement accordingly, an instruction that it is necessary to setup a financial arrangement with the patient; an instruction to collect promissory note due for an indicated amount, an instruction to collect unpaid balance or setup a new financial arrangement; an instruction to charge out unpaid balance to a service provider credit account, an instruction to collect on an auto debit contract for an indicated amount, an instruction to see comments for the patient, information that the patient has an remaining amount in a contract and an instruction to arrange additional treatment and make appointment, information that a claim was denied by an insurance carrier and an instruction to verify insurance coverage and have the patient contact the insurance carrier.

12. The system of claim 10, further comprising a computer network which is used to access the multiple databases.

13. The system of claim 10, further comprising a computer network and one or more client computers which remotely access the computer and the multiple databases over the computer network.

14. The system of claim 13, wherein the computer network is Internet.

15. The system of claim 10, wherein all patient information in the first window are displayed in a recursive, expandable and collapsible outline form.

16. An automated system for collecting and displaying patient health and financial information from multiple databases, and determining and displaying patient financial management action items based on the patient information and business rules, comprising:
means for accessing, in response to an input of a patient ID information, all patient information from at least the first database and the second database;
means for determining whether there exists patient financial management action items based on predefined business rules and all collected patient health and financial information;
means for displaying all patient health and financial information in a first window of a display; and
means for displaying the patient financial management action items in a second window overlaid onto the first window displaying all patient information, wherein the second window only pops up if there exists an action item.

17. The system of claim 16, further comprising a computer network which is used to access the multiple databases.

18. The system of claim 16, further comprising a computer network and one or more client computers which remotely access the computer and the multiple databases over the computer network.

19. The system of claim 18, wherein the computer network is Internet.

20. Computer-executable process steps for displaying patient health and financial information, together with any patient financial management action items, by collecting information from at least two databases including a first database which includes patient health information comprising patient ID information and healthcare data and a second database which includes patient financial information comprising patient ID information and billing and accounting data, wherein the process steps are stored on a computer-readable medium, the steps comprising:
a step for accessing, in response to an input of a patient ID information, all patient information from at least the first database and the second database;
a step for determining whether there exists patient financial management action items based on predefined business rules and all collected patient health and financial information;
a step for displaying all patient health and financial information in a first window of a display; and
a step for displaying the patient financial management action items in a second window overlaid onto the first window displaying all patient information, wherein the second window only pops up if there exists an action item.

21. Computer-executable process steps of claim 20, wherein the patient health and financial information in the first window includes a current date, any amount that a patient owes on the current day, total balance for a family member dependent to the patient, total family balance for a family account, an amount of payment last received and a date of last treatment, a date of next appointment and total amount due on the date of next appointment, any existing financial arrangement and a status of the arrangement, and, for a new treatment plan, a date of diagnosis, a total Usual and Customary Rate (UCR) amount, expected insurance coverage, expected patient payment amount, and any prior balance; and
wherein the patient financial management action items in the second window include one or more of information that a financial arrangement with the patient is less than any prior balance plus a cost for new treatment, and an instruction to modify the financial arrangement accordingly, an instruction that it is necessary to setup a financial arrangement with the patient, an instruction to collect promissory note due for an indicated amount, an instruction to collect unpaid balance or setup a new financial arrangement, an instruction to charge out unpaid balance to a service provider credit account; an instruction to collect on an auto debit contract for an indicated amount, an instruction to see comments for the patient, information that the patient has a remaining amount in a contract and an instruction to arrange additional treatment and make appointment, information that a claim was denied by an insurance carrier and an instruction to verify insurance coverage and have the patient contact the insurance carrier.

22. Computer-executable process steps of claim 20, wherein the input of a patient ID information and accessing all patient information from at least the first database and the second database are conducted over a computer network.

23. Computer-executable process steps of claim 20, wherein the input of a patient ID information and accessing all patient information from at least the first database and the second database are conducted remotely over a computer network from multiple branch offices.

24. Computer-executable process steps of claim 23, wherein the input of a patient ID information and accessing all patient information from at least the first database and the second database are conducted over Internet.

25. Computer-executable process steps of claim 20, wherein all patient information in the first window are displayed in a recursive, expandable and collapsible outline form.
